(19) United States
(12) Patent Application Publication
(10) Pub. No.: US 2009/0087252 A1
(43) Pub. Date: Apr. 2, 2009

(54) Device for limiting the angle of rotation of an object mounted in rotatable manner and optical observation apparatus

(76) Inventor: Daniel Kolster, Oberkochen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/283,744

(22) Filed: Sep. 15, 2008

(30) Foreign Application Priority Data
Sep. 14, 2007 (DE) 10 2007 043 845.3

(51) Int. Cl. F16C 11/04

(52) U.S. Cl. 403/117

(57) ABSTRACT

First, a device (10) for limiting the angle of rotation of an object that is mounted in a rotatable manner is described, having a base element (12) that is mounted in a rotatable manner around an axis of rotation (11) for the uptake of an object to be rotated, and having a mechanism (13) for limiting the angle of rotation. Therefore, so that the rotation of base element (12) can be limited, for example, to a full 360 degrees, it is provided according to the invention that the mechanism (13) for limiting the angle of rotation has a pivoting stop (15) that is mounted in a rotatable manner around a pivoting axis (14), this stop being disposed on base element (12), that the mechanism (13) for limiting the angle of rotation has at least one, preferably two or more stops (16, 17) for limiting the pivoting movement of the pivoting stop (15) and that the mechanism (13) for limiting the angle of rotation has at least one counter-stop (18), which cooperates with pivoting stop (15). In addition, an optical observation apparatus having such a device (10) is described.

The present invention first relates to a device for limiting the angle of rotation of an object mounted in a rotatable manner according to the preamble of patent claim 1. In addition, the invention also relates to an optical observation apparatus as well as special uses of such a device for limiting the angle of rotation.

In the prior art, there exist innumerable solutions, in which objects of all types are mounted in a rotatable manner, and in which it is desired to limit the rotating movement in one way or another.

For example, a solution from the field of operating microscopes is described in DE 103 38 498 A1. In this solution, individual components of the operating microscope, here an operating element, are disposed so as to rotate on a base unit. The rotation occurs here by way of a ball-and-socket linkage assembly. In addition, a mechanism is provided for limiting the rotation, which is formed by corresponding recesses in the ball-joint seat and the ball joint recess, whereby the two recesses jointly enclose a linker element.

A solution that lies in another field of technology is described, for example, in DD 227 202 A1. In this publication, a device for limiting the angle of rotation is disclosed, which has one or two stops. These stops are disposed on a disk and are bent at right angles, so that they can engage in a front plate.

Yet another solution is described in DE 23 46 327 A1. A device for limiting the angle of rotation is disclosed therein, which permits angles of rotation of at least 360 degrees. This is achieved by means of an entraining or driving lever to which a stop is assigned, which in turn is held in movable manner between two stops disposed at a distance from one another.

Other solutions for limiting the angle of rotation, for example, make use of corresponding strips or similar arrangements.

The disadvantage in the known solutions is that they are usually expensive in their construction, which is of particular disadvantage relative to robustness, durability and manufacturing costs. In several of the known solutions, for example, additional expense must be applied for the seating of an additional disk with stops. Further, in several cases, it is desired to be able to carry out a limiting of the angle of rotation to a precisely defined angle region, which cannot always be achieved with the known solutions, although this may not always be wanted.

Proceeding from the named prior art, the object of the present invention is to further develop a device for limiting the angle of rotation of the type named initially, in such a way that a limiting of the angle of rotation to a precisely defined angle region can be achieved in a structurally simple manner. In addition, a correspondingly improved observation apparatus will be provided as well as particularly advantageous uses for such a device.

This object is achieved according to the invention by the device for limiting the angle of rotation with the features according to the independent patent claim 1, the optical observation apparatus with the features according to the independent patent claim 11* as well as the special uses according to the independent patent claims 13 and 14. Additional features and details of the invention derive from the subclaims, the description and the drawings. Here, features and details, which are described in connection with the device according to the invention, of course, also apply in connection with the optical observation apparatus according to the invention, and vice versa. The same applies also to the uses according to the invention. *sic; claim 12?—Trans. Note.

By the configuration of the device for limiting the angle of rotation according to the invention, a simple stop for limiting the angle of rotation to a precisely defined range is created, for example, a simple stop for limiting the angle of rotation to a rotation of at least 360 degrees. Thus, for example, a limiting of the angle of rotation to a full 360-degree rotation, but also to a rotation greater than 360 degrees, is created. Of course, a stop for limiting the angle of rotation to a rotation of less than 360 degrees can also be provided by means of the device according to the invention.

According to the first aspect of the invention, a device for limiting the angle of rotation of an object mounted in a rotatable manner is provided, having a base element mounted in a rotatable manner around an axis of rotation for the uptake of an object to be rotated, as well as a mechanism for limiting the angle of rotation. The device is characterized according to the invention in that the mechanism for limiting the angle of rotation has a pivoting stop that is mounted in a rotatable manner around a swiveling axis, this stop being disposed on the base element, in that the mechanism for limiting the angle of rotation has at least one, preferably two stops for limiting the pivoting movement of the pivoting stop and in that the mechanism for limiting the angle of rotation has a counter-stop which cooperates with the pivoting stop.

The device according to the invention first has a base element which serves for the uptake or fastening of an object to be rotated. For this purpose, the base element is mounted in a rotatable manner around an axis of rotation. Of course, the invention is not limited to specific configurations for the base element. Such base elements are already known from the prior art and are familiar to persons skilled in the art working in this field. In the further course of the description, several advantageous, but non-exclusive examples will be explained of how such a base element can be configured.

In addition, the device makes available a mechanism for limiting the angle of rotation. This mechanism is configured in a special way according to the invention.

A fundamental feature provides that the mechanism for limiting the angle of rotation has a pivoting stop that is mounted in a rotatable manner around a pivoting axis. This pivoting stop is disposed on the base element. The fundamental mode of operation of the pivoting stop is such that this stop can be pivoted out from a position of rest in both directions relative to the position of rest. In particular, it can be provided that this stop can be pivoted out from a vertical or oblique position of rest. This can be carried out symmetrically (the stop can be pivoted out equally far in both directions relative to the position of rest) as well as asymmetrically (the stop can be pivoted out to a different extent in the two directions relative to the position of rest). The pivoting stop thus corresponds in its mode of operation to a type of pendulum.

Thus, it is important according to the present invention that the pivoting stop is disposed on the base element in such a way that that the pivoting stop also rotates along with the rotation of the base element. In addition, for this purpose, the pivoting stop can also still be pivoted around the pivoting axis, so that the pivoting stop is rotated or pivoted in a double manner, whereby, in particular, the two pivoting and rotating movements can be carried out independently of one another. The way in which the pivoting of the pivoting stop can be carried out advantageously will be explained in more detail on the basis of several advantageous, but non-exclusive examples in the further course of the description.

In order to keep the pivoting movement of the pivoting stop in defined paths, the mechanism for limiting the angle of rotation provides one, preferably two or more stops. In an advantageous embodiment, two stops can be provided. In another advantageous embodiment, for example, four stops can be provided. Several advantageous, but non-exclusive examples will also be described for this below.

Finally, the mechanism for limiting the angle of rotation provides at least one counter-stop, which cooperates with the pivoting stop. Cooperation is to be understood to mean that the two stops are in contact with one another at least temporarily, but without being fastened to one another. The two stops merely lie loose next to one another. According to the present invention, two counter-stops can also be provided. In this way, a limiting of the angle of rotation to a rotation of less than 360 degrees can be particularly provided. Depending on the desired limit of rotation in each case, the counter-stops can be correspondingly provided at a distance from one another. Thus, it is also conceivable that the counter-stops, when viewed from the axis of rotation of the base element, can be provided at different distances from the latter, so that the distances from the axis of rotation to the two counter-stops are different.

By the configuration of the mechanism for limiting the angle of rotation according to the invention, it is achieved that the physical width of the pivoting stop can be compensated for, so that the rotation of the base element and thus of an object attached in or on this element can be limited in the desired way, for example to a full 360 degrees, to angles greater than 360 degrees, but, of course, also to angles smaller than 360 degrees.

In the device for limiting the angle of rotation, it can be basically provided that the at least one stop is provided separately from the base element. However, it is preferably provided that the at least one stop for limiting the pivoting movement of the pivoting stop is provided in the base element.

This can be realized in very different ways. An advantageous, but non-exclusive example will be described below for this. It can be advantageously provided that the base element has at least one angled recess, that the arms of the recess each form a stop and that the pivoting stop which is mounted in a rotatable manner around a pivoting axis and whose pivoting movement is limited by the arms of the recess is disposed in the region of at least one angled recess. Therefore, at least one recess whose two limits each form an arm that serves as a mechanical stop for the pivoting stop is integrated into the base element. The arms have an oblique path.

It can therefore be provided that a recess, as viewed from the central point of the base element, widens toward its outer ends. If, for example, two such recesses are provided, the first of the two recesses can be formed in the named way. The second recess is then advantageously formed in such a way that, when viewed from its outer ends, widens toward the central point of the base element. In such a case, the pivoting stop is then advantageously provided and disposed in the region of the second recess.

The limiting of the angle of rotation can be adjusted in the desired way by varying the angle limited by the arms of the at least one angled recess. By an appropriate configuration, it is particularly possible to create a limiting of the angle of rotation to a full 360-degree rotation. A differently selected angle aperture would, however, also permit an angle of more than or less than 360 degrees.

The counter-stop can be advantageously mounted in fixed position. Here, it is preferably provided seated in position relative to the axis of rotation of the base element. For example, it is conceivable that the counter-stop is mounted or fastened or formed in a housing. The magnitude of the angle for limiting the angle of rotation can be varied, for example, even to more than 360 degrees, by the distance between the counter-stop and the pivoting axis of the pivoting stop.

The pivoting stop preferably can extend out over the outer limit of the base element. In this case, it is primarily the component of the pivoting stop that projects out above the base element that cooperates with the counter-stop. The magnitude of the angle for limiting the angle of rotation can be varied over the length of the pivoting stop.

In another configuration, the pivoting stop can be disposed rotatably on the base element by means of a pin, a bolt or a screw. Of course, the invention is not limited to the named examples. It is only important that the fastening is selected in a way that permits a pivoting movement around the swiveling axis.

As was described further above, the base element can be configured in very different ways. For example, but not exclusively, the base element can be formed as a disk or as a ring. In the last-named case, a ring unit surrounds and limits a ring opening. The axis of rotation of the base element is then formed in the central point of the ring opening. Then the pivoting stop is disposed on the ring unit in the manner previously described.

Advantageously, the pivoting stop can be adapted to the contour of the counter-stop, at least in regions.

Preferably, the pivoting stop can also be formed as a profile. Of course, the invention is not limited to specific profiles. These profiles rather are adapted to the expected field of application of the device for limiting the angle of rotation, the configuration of the counter-stop and similar considerations. For example, but not exclusively, the pivoting stop can be configured in the form of a four-cornered profile. Such a profile can have a rounded contour for improvement of the pivoting properties in the region of the pivoting axis, so that the four-cornered profile forms the basic contour in this case.

It is particularly possible by means of an appropriate configuration of the pivoting stop, e.g. by the selection of a specific width and/or length, to create a limiting of the angle of rotation to a full 360-degree rotation. A differently selected width and/or length would, however, also permit an angle of more than or less than 360 degrees.

Advantageously, the pivoting stop can have at least one stop region for the counter-stop. Here it can be particularly provided that the stop region is adapted to the contour of the counter-stop, at least in regions. If two counter-stops are provided, and the two counter-stops are disposed at different distances when viewed from the central point of the base element, the stop region can be adapted in shape correspondingly.

For example, it may be provided that the axis of rotation of the base element and the pivoting axis of the pivoting stop are distanced from one another. This is the case, for example, when the base element is formed in ring shape. The pivoting axis can also coincide with the axis of rotation. This may be the case, for example, when an aperture in the center of the base element is not necessary. For example, it may be provided that the pivoting axis of the pivoting stop, when viewed from its free end, lies in front of the axis of rotation of the base element. In another configuration, however, it can also be provided that the pivoting axis, when viewed from the free end of the pivoting stop, lies behind the axis of rotation. In the last-named case, the pivoting stop extends above the base element and preferably through the axis of rotation of the base element. If the base element is configured in ring shape, the pivoting stop extends through the ring opening of the ring-shaped base element.

The device for limiting the angle of rotation can be particularly advantageously formed for a rotation of at least 360 degrees.

A device for limiting the angle of rotation as described above can be used in connection with the most varied technical fields. Advantageously, it can be applied in the field of medical technology, for example, in operating microscopes.

According to another aspect of the invention, an optical observation apparatus, in particular a microscope, is provided, having a device for limiting the angle of rotation according to the invention, as described above, on whose base element at least one component of the observation apparatus is mounted rotatably and limited in its angle of rotation.

In order to avoid repetition, reference is made in this place to the full content of the discussion presented above for the device for limiting the angle of rotation according to the invention.

The device according to the invention can be used advantageously in different ways. For example, such a device can be used for the rotatable but rotation-limited seating of a component of a microscope, in particular an operating microscope. In another configuration, such a device can also be used, for example, as a suspension within a microscope, in particular an operating microscope—e.g., an opthalmologic microscope.

The invention will now be explained in more detail based on an embodiment example with reference to the attached drawings. Here:

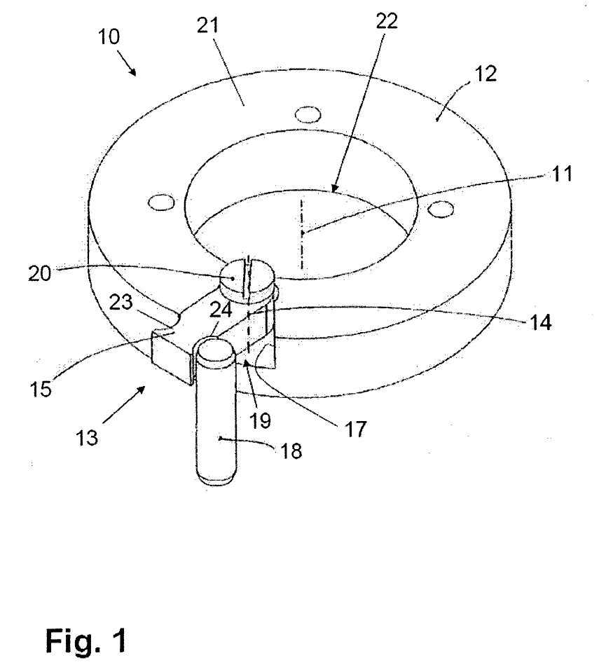

FIG. 1 shows a perspective view of a first example of embodiment of a device for limiting the angle of rotation of an object that is mounted in a rotatable manner according to the invention;

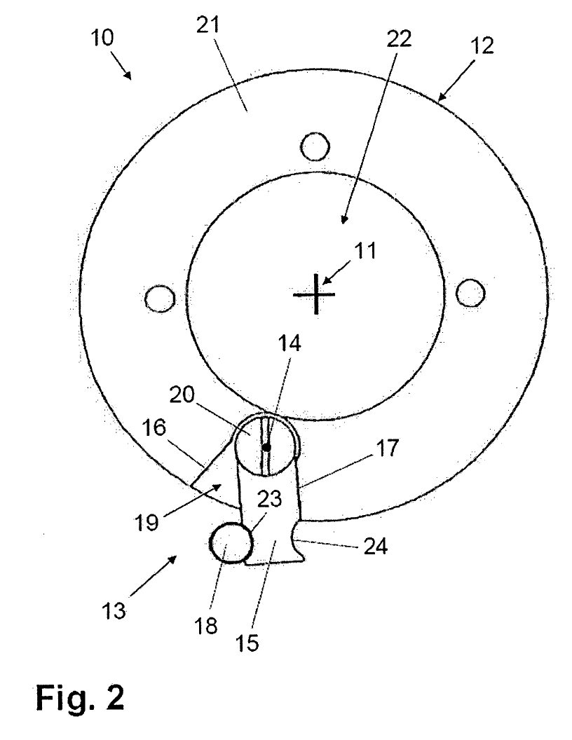

FIG. 2 shows a view from the top of the device shown in FIG. 1 with a 0-degree stop of the pivoting stop;

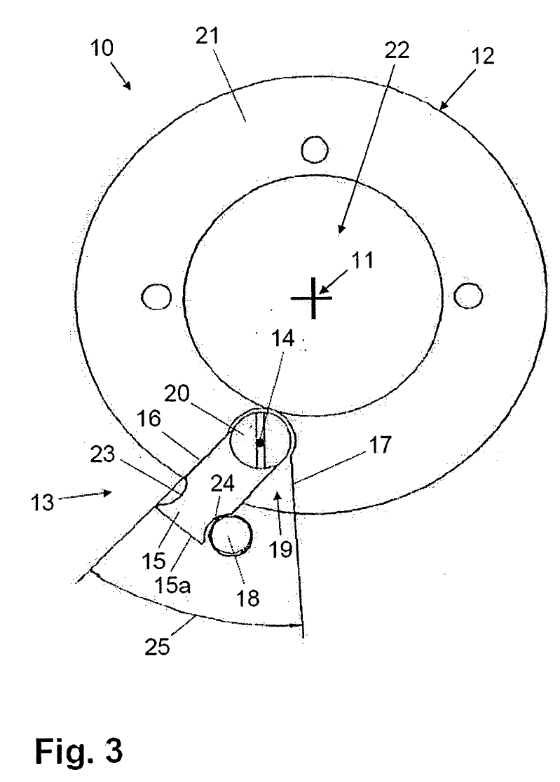

FIG. 3 shows a view from the top of the device shown in FIG. 1 with a 360-degree stop of the pivoting stop; and

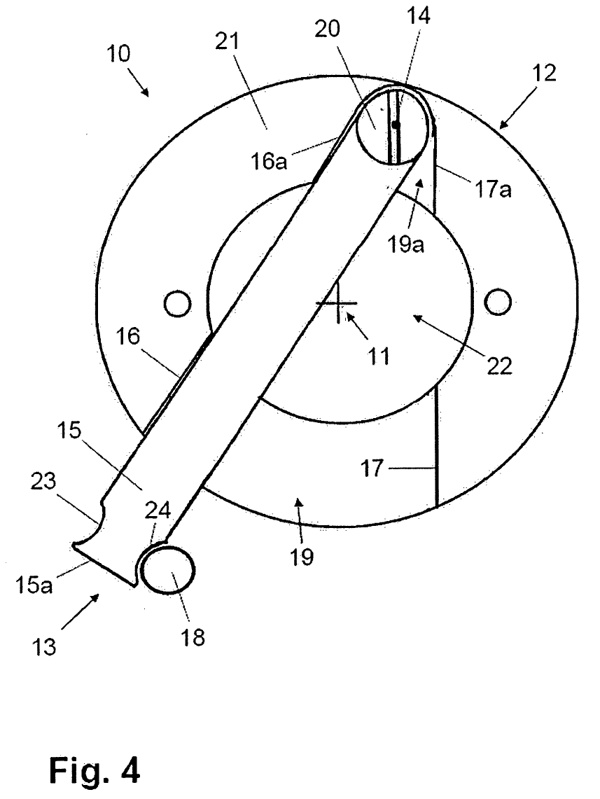

FIG. 4 shows a view from the top of a second example of embodiment of a device for limiting the angle of rotation according to the invention.

A device 10 for limiting the angle of rotation is shown in FIGS. 1 to 3. Device 10 first has a ring-shaped base element 12, which is mounted around an axis of rotation 11. Base element 12 consists of a ring unit 21, on or in which an object to be rotated (not shown) can be fastened. Ring unit 21 surrounds a ring opening 22, in the central point of which is found the axis of rotation 11. As soon as base element 12 is rotated around axis of rotation 11, the object to be rotated also rotates with it in the same way.

In order to assure that the rotation of the base element can be limited, for example, to a full 360-degree rotation, device 10 provides a mechanism 13 for limiting the angle of rotation. This mechanism 13 consists of a number of structural elements. First of all, mechanism 13 provides an angled recess 19, which is formed in ring unit 21 of base element 12. Angled recess 19 is limited by two side arms 16, 17, each of which forms a stop for a pivoting stop 15. Angled recess 19 is formed in such a way that, when viewed from the axis of rotation 11, widens toward the outer edge of ring unit 21, and in fact by an angle 25 enclosed by the angled recess (FIG. 3).

A pivoting stop 15, which is attached to base element 12 by means of a screw 20 so that it can pivot around a pivoting axis 14 is provided and is mounted in pivotable manner around pivoting axis 14 in angled recess 19. Pivoting stop 15 is shaped in the form of a four-cornered profile, wherein a part of pivoting stop 15 extends out over the outer edge of base element 12. Pivoting stop 15 cooperates with a counter-stop 18, which can be disposed, for example, in fixed position in a housing (not shown). In the region of the free end of pivoting stop 15, which extends out over the outer edge of base element 12, stop regions 23, 24 are provided for the counter-stop, these regions being adapted to the contour of counter-stop 18.

A situation is shown in FIG. 2, which corresponds to a 0-degree stop. A situation is shown in FIG. 3, which corresponds to a 360-degree stop. It can thus be assured by the configuration of mechanism 13 for limiting the angle of rotation that the physical width of pivoting stop 15 can be compensated for, so that the rotation of base element 12 can be limited to a full 360 degrees.

Another example of embodiment of a device 10 for limiting the angle of rotation according to the invention is shown in FIG. 4. The individual components here correspond to the components of the example of embodiment shown in FIGS. 1 to 3, so that the same components are provided with identical reference numbers. Reference is made here in addition to the full content of the discussions for FIGS. 1 to 3 relative to the fundamental structure.

The main difference between the device 10 shown in FIGS. 1 to 3 and the device 10 according to FIG. 4 consists of the fact that the pivoting stop 15 in FIG. 4 is fastened in a different way to base element 12. In the example of embodiment shown in FIGS. 1 to 3, it is provided that the pivoting stop 15 is disposed in base element 12 in such a way that pivoting axis 14 of pivoting stop 15, when viewed from the free end 15a (see FIG. 3) of pivoting stop 15, lies in front of the axis of rotation 11 of base element 12. In the example of embodiment according to FIG. 4, however, the pivoting axis 14 of pivoting stop 15, when viewed from its free end 15a, lies behind the axis of rotation 11 of base element 12.

The device 10 for limiting the angle of rotation, which is shown in FIG. 4, has two angled recesses 19, 19a (in FIGS. 1 to 3, only one angled recess 19 is provided), each of the side arms of these recesses forming corresponding stops 16, 16a and 17, 17a for limiting the pivoting movement of pivoting stop 15. Pivoting stop 15 extends out over base element 12, and, in particular, over ring opening 22 and axis of rotation 11. The advantage of such a configuration is that the angled recess 19, which is provided in the vicinity of counter-stop 18, can be made larger. In addition, the region of pivoting stop 15, which extends out over the outer limit of base element 12, can also be made larger. A limiting of the angle of rotation for angles larger than 360 degrees can thus be provided in an advantageous way with a device shown in FIG. 4.

### LIST OF REFERENCE NUMBERS

10 Device for limiting the angle of rotation
11 Axis of rotation
12 Base element
13 Mechanism for limiting the angle of rotation
14 Pivoting axis
15 Pivoting stop
15a Free end of the pivoting stop
16 Stop for limiting the pivoting movement of the pivoting stop
16a Stop for limiting the pivoting movement of the pivoting stop
17 Stop for limiting the pivoting movement of the pivoting stop
17 Stop for limiting the pivoting movement of the pivoting stop
18 Counter-stop
19 Angled recess
19a Angled recess
20 Screw
21 Ring unit
22 Ring opening
23 Stop region in the pivoting stop for the counter-stop
24 Stop region in the pivoting stop for the counter-stop
25 The angle enclosed by the angled recess

1. A device for limiting the angle of rotation of an object mounted in a rotatable manner, having a base element that is mounted in a rotatable manner around an axis of rotation for the uptake of an object to be rotated, as well as a mechanism for limiting the angle of rotation, hereby characterized in that the mechanism for limiting the angle of rotation has a pivoting stop mounted in a rotatable manner around a pivoting axis, this pivoting stop being disposed on base element, in that the mechanism for limiting the angle of rotation has at least one, preferably two or more stops for limiting the pivoting movement of pivoting stop and in that the mechanism for limiting the angle of rotation has at least one counter-stop, which cooperates with pivoting stop.

2. The device according to claim 1, further characterized in that the at least one stop for limiting the pivoting movement of pivoting stop (is provided on base element.

3. The device according to claim 1, further characterized in that base element has at least one angled recess, in that each of the side arms of recess has a stop and in that the pivoting stop that is mounted in a rotatable manner around a pivoting axis is disposed in the region of at least one angled recess and is limited in its pivoting movement by the arms of the at least one recess.

4. The device according to claim 1, further characterized in that the at least one counter-stop is mounted in fixed position relative to axis of rotation.

5. The device according to claim 1, further characterized in that pivoting stop extends out over the outer limit of base element.

6. The device according to claim 1, further characterized in that pivoting stop is disposed in base element in rotatable manner by means of a pin, a bolt or a screw.

7. The device according to claim 1, further characterized in that base element is formed in ring shape.

8. The device according to claim 1, further characterized in that pivoting stop is adapted to the contour of the at least one counter-stop, at least in regions.

9. The device according to claim 1, further characterized in that pivoting stop has at least one stop region for the at least one counter-stop.

10. The device according to claim 1, further characterized in that the axis of rotation of base element and the pivoting axis of pivoting stop are distanced from one another, or in that the axis of rotation of base element and the pivoting axis of pivoting stop coincide.

11. The device according to claim 1, further characterized in that this device for limiting the angle of rotation is formed for a rotation of at least 360 degrees.

12. An optical observation apparatus, in particular a microscope, having a device for limiting the angle of rotation according to claim 1, on whose base element at least one component of the observation apparatus is mounted rotatably and limited in its angle of rotation.

13. Use of a device for limiting the angle of rotation according to claim 1 for the rotatable and rotation-limited seating of a component of a microscope, in particular an operating microscope.

14. Use of a device for limiting the angle of rotation according to claim 1 as a suspension within a microscope, in particular, an operating microscope.
